(19) United States
(12) Patent Application Publication
(10) Pub. No.: US 2009/0032631 A1
(43) Pub. Date: Feb. 5, 2009

(54) Spinning Reel

(76) Inventor: Robert W. Koelewyn, Stratford, CT (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/223,640

(22) PCT Filed: Feb. 9, 2007
(86) PCT No.: PCT/US07/03498

§ 371 Date: Aug. 5, 2008

Related U.S. Application Data
(60) Provisional application No. 60/771,996, filed on Feb. 9, 2006.

(51) Int. Cl. A01K 89/02

(52) U.S. Cl. 242/257; 242/283; 242/291; 242/323

(57) ABSTRACT

An improved spinning reel of the type has a body, a rotor and line pick-up rotatably mounted on the body, a shaft mounted for reciprocating movement with respect to the body and rotor, a spool rotatably mounted on the shaft, a drag assembly permitting adjustably controlled rotation of the spool with respect to the shaft to release line at an adjusted drag force, and a handle drive mounted on the body for rotating the rotor and reciprocating the shaft. The handle arm has a base arm and a distal arm adjustably secured together for selecting an effective handle length and radius of rotation of the handle knob. The handle knob defines a channel, and a plurality of ganged O-rings deployed in the channel to provide the grip surface of the knob, and may be oval. The drag assembly has two drag washers deployed on drag washer surfaces defined on opposite sides of a spool cross wall, a first clutch plate keyed to the shaft and operating on one of the drag washers, a second clutch plate keyed to the shaft and acting on the other of the drag washers, and at least one spring adjustably compressed to apply spring force biasing on the second clutch plate, the drag washers and spool cross wall against the first clutch plate. The drag adjustment knob is mounted adjacent to and has a laarge diameter than an outer spool end wall so that drag adjustment can be made from the handle area. The lip of the drag adjustment knob and the periphery of the spool wall define a gap therebetween, and the drag adjustment knob defines a plurality of openings establishing air communication to the gap. A line roller is rotatably mounted on the mounting stud by a roller bearing, and the line roller is secured on the mounting stud by at least one O-ring captured between the roller bearing and a flange of the line roller.

### RELATED APPLICATION

This application claims priority from my U.S. Provisional Application Ser. No. 60/771,996 filed Feb. 9, 2006.

### FIELD OF THE INVENTION

The invention herein relates to an improved spinning reel for fishing.

### BACKGROUND OF THE INVENTION

Fishing is one of the most popular pastimes and having excellent fishing gear contributes to the joy of the sport. A spinning reel is a basic item of fishing gear.

One of the user's priorities in a spinning reel is having a satisfactory handle with which to operate the reel. This is important because the handle is the user/reel interface. Another important feature is the drag system. The drag system should operate smoothly and predictably and be easy to adjust.

A spinning reel is designed to pick up and release line by means of line pick-ups, and these also should to be smooth and predictable as they are part of the line release path when utilizing the drag system.

Further, it is important that the spinning reel perform as well as possible, including providing smooth line release for maximum distance on casts.

Lastly, the spinning reel should be easy to operate, sturdy, and contribute to convenience of fishing.

### SUMMARY OF THE INVENTION

It is the principal object of the invention herein to provide a high quality spinning reel.

It is an additional object of the invention herein to provide a spinning reel with a comfortable handle interface with the user.

It is a further object of the invention herein to provide a spinning reel with a smooth and reliable drag system that is easy to adjust.

It is another object of the invention herein to provide a spinning reel that maximizes cast distance.

It is also an additional object of the invention to minimize localized strain on line as it plays out from a spinning reel spool.

It is also a further object of the invention herein to provide a spinning reel that assists in safely and conveniently managing hooks when the reel and a rod it is mounted upon are not in use.

In carrying out the foregoing objects of the invention, a spinning reel is provided having a body and a rotor with at least one line pick up rotatably mounted on the rotor. A shaft is slidingly mounted on the body for reciprocating motion along the axis of the rotor, and a spool is rotatably mounted on the shaft. A drag assembly permits adjustably controlled rotation of the spool with respect to the shaft to release line at an adjusted drag force. A handle drive is mounted on the body for rotating the rotor and reciprocating the shaft.

According to aspects of the invention, the handle drive includes a handle having an arm and a handle knob at the distal end thereof. The handle arm is adjustably articulated to provide selected effective length of the handle arm, so that the user can select a desired leverage and radius of rotation of the handle knob. The knob may have an outer surface formed of ganged, adjacent O-rings, and the outer surface of the knob may be provided around or in an oval configuration, for a comfortable grip.

In other aspects of the invention, a line rollers of the rotor line pick up is mounted on a bearing, and is retained by a simple O-ring buttress.

Additional aspects of the invention include a drag assembly wherein drag washers are biased against a cross wall of the spool. The drag assembly includes a drag adjustment knob which is rotated to compress springs biasing the drag washers against the spool cross wall surfaces. The spool is supported on ball bearings to isolate the drag forces.

The drag adjustment knob substantially covers an outer end wall of the spool, with a small gap between the periphery of the drag adjustment knob and the peripheral rim of the spool outer end wall. The drag adjustment knob includes a plurality of air induction openings for introducing air between the drag adjustment knob and the spool, and the air is believed to flow from the gap to assist in dispensing line from the reel.

The invention is also carried out by providing the drag adjustment knob with a diameter at least the same as or larger than the diameter of the adjacent spool so that the periphery of the drag adjustment knob can be engaged by the user from adjacent the sspool periphery. The diameter of the drag adjustment knob is preferably at least incrementally larger than the diameter of the adjacent spool end wall and has a smooth peripheral edge, so that line playing out from the spool may have contact with the smooth peripheral edge. The periphery of the drag adjustment knob is exposed for manipulation.

In still further aspects of the invention, the reel defines a hook holder for receiving and retaining a hook between uses of the reel. The hook holder is preferably formed in a removable hook holder post extending from a mounting leg of the reel.

The foregoing and other objects and features of the invention will in part be recognized by those skilled in the art and will in part appear in the following detailed description of the preferred embodiment and the claims, taken together with the drawings.

### BRIEF DESCRIPTION OF DRAWINGS

FIG. 1 is a perspective view of a spinning reel according to the invention herein;

FIG. 2 is a longitudinal sectional view of the spinning reel of FIG. 1, taken toward the rear handle side of the spinning reel;

FIG. 3 is an exploded perspective view of a cover and handle drive of the spinning reel of FIG. 1;

FIG. 4 is an exploded perspective view of the body, mounting leg and rotor drive of the spinning reel of FIG. 1;

FIG. 5 is an exploded perspective view of an alternative handle for the spinning reel of FIG. 1;

FIG. 6 is an exploded perspective view of the rotor and rotor drive of the spinning reel of FIG. 1;

FIG. 7 is an enlarged sectional view of a line roller of the spinning reel of FIG. 1;

FIG. 8 is an exploded perspective view of the spool and part of the drag assembly of the spinning reel of FIG. 1;

FIG. 9 is a perspective view of the spool of the spinning reel of FIG. 1;

FIG. 10 is a perspective view of another part of the drag assembly of the spinning reel of FIG. 1;

FIG. 11 is another perspective view of the spool of the spinning reel of FIG. 1;

FIG. 12 is a perspective view of a clicker plate of the drag assembly, also shown in FIG. 10; and

FIG. 13 is an enlarged fragmentary view, partially in section, of the spinning reel of FIG. 1.

The same reference numerals refer to the same elements throughout the various figures.

### DETAILED DESCRIPTION OF PREFERRED EMBODIMENTS

The various figures show a spinning reel 10 and sub-assemblies and parts thereof. The spinning reel 10 generally comprises a body 12 having a mounting leg 14 and foot 16 for mounting the spinning reel 10 on a fishing rod, not shown, in the usual manner. The spinning reel 10 further generally comprises a handle drive 20 with a handle arm 22 and a handle knob 24, and a rotor 30 with line pickups 32 and 34. A spool 40 is mounted for reciprocating movement with respect to the rotor 30 and body 12, and a drag assembly 50 associated with the spool 40 includes a drag adjustment knob of 52.

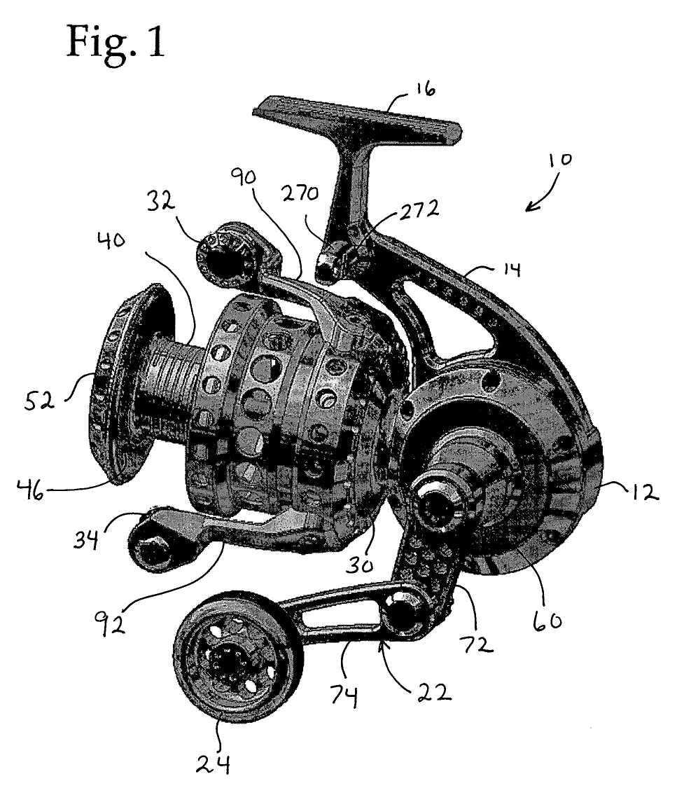

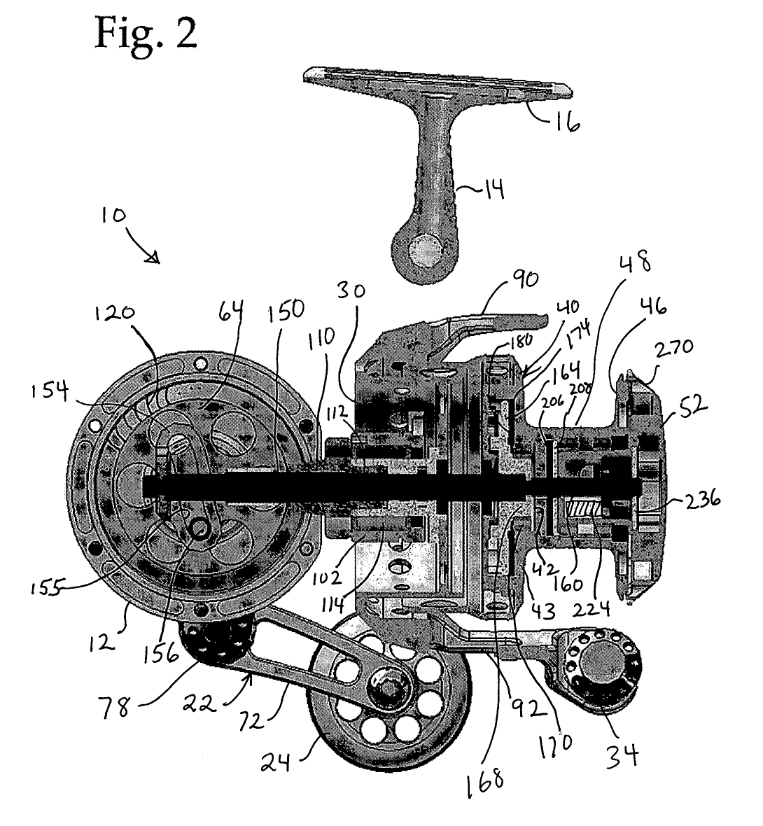

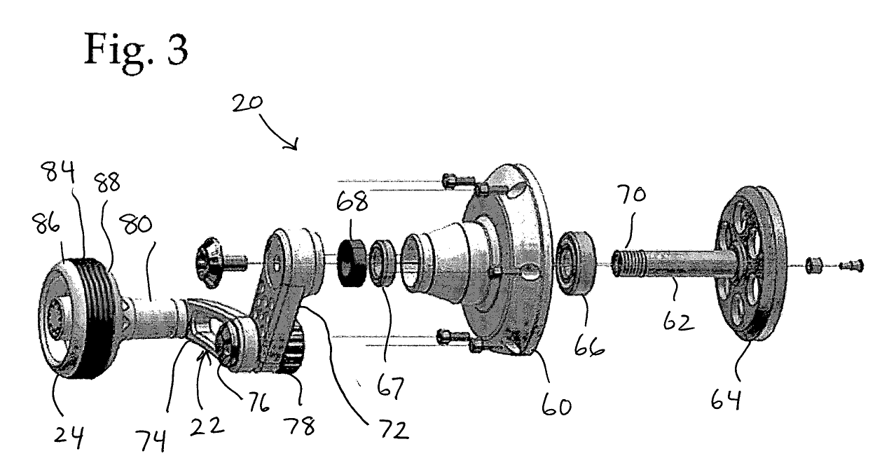

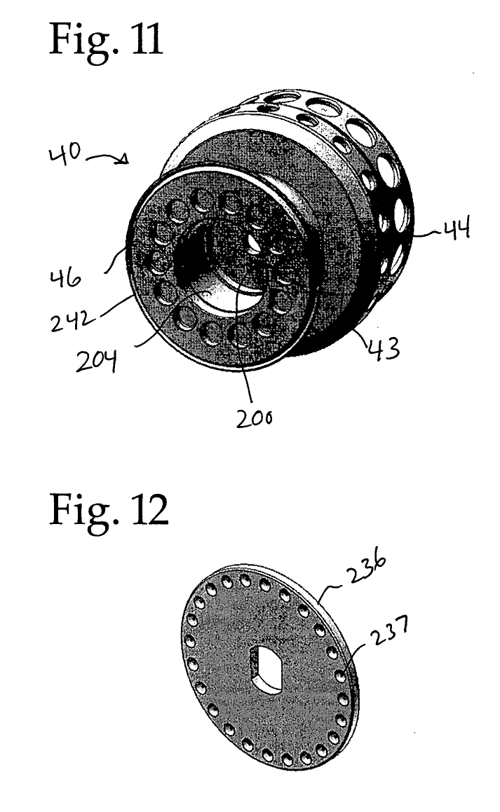

The general operation of the spinning reel 10 is that turning of the handle drive 20 rotates the rotor 30 and reciprocates the spool 40 under the line pickups 32 and 34. The handle drive 20 is secured against reversing by a one-way clutch; however, the drag assembly 50 permits rotation of the spool 40 to release line over the line pickups 32, 34 at a drag force adjusted by the drag adjustment knob 52. Parts of the spinning reel 10 and their operative relationship, as well as other operating principles, will now be discussed with reference to the various drawings. FIG. 1 shows the spinning reel 10 in a perspective view, and FIG. 2 is a longitudinal sectional view of the spinning reel 10, looking toward the rear side of the spinning reel 10 as it is oriented in FIG. 1. The remaining FIGS. 3 through 13 show subassemblies of the spinning reel 10, often in exploded views so that the individual parts assembled together in FIGS. 1 and 2 are better seen. Thus, in considering the discussions of FIGS. 3-13, reference should be made back to FIGS. 1 and 2 for an understanding of how the parts fit into the assembled spinning reel 10.

With reference to FIG. 3, the handle drive 20 is illustrated in detail. A cover 60 is mounted to the body 12, and the cover 60 rotatably mounts a handle shaft 62 and drive gear 64 on handle shaft bearings 66 and 67. A seal 68 is also provided about the shaft 62.

Handle arm 22 is mounted on the distal end 70 of the handle shaft 62. The handle arm 22 is provided in two portions; namely a base handle arm 72 and a distal handle arm 74. They are secured together at an angle by handle arm bolt 76 and nut 78, the nut 78 being large and fluted for loosening the bolt and permitting adjustment of the angle A between the base handle arm 72 and distal handle arm 74. At the free end of the distal handle arm 74, a handle knob 24 is mounted on a spindle 80. The handle knob 24 is mounted on bearings and is freely rotatable. Its exterior peripheral surface is provided with a grip 82, including a plurality of O-rings 84 received in ganged side-by-side flanking relationship between flanges 86 and 88 of the handle knob 24. The O-rings are standard, commercially available neoprene or other O-rings with a rubber-like texture and provide good traction and an excellent feel to the handle knob.

The articulated handle arm 22 permits the user to select the radius of rotation of the handle knob 24 and hence the leverage provided by the handle arm 22. If the base handle arm 72 and distal handle arm 74 are adjusted at a smaller angle A, it reduces the radius of rotation, which is also the effective length of the handle arm 22 from the axis of rotation of drive shaft 62 to the axis of the spindle 80. A smaller included angle provides less leverage, but also provides for faster winding. If the base handle arm 74 and distal handle arm 74 are set at a larger included angle A, including up to 180 degrees providing a substantially straight handle arm 22, the radius of rotation or effective length of the handle arm 22 is increased and the leverage applied to the drive shaft 62 is also increased. However, that adjustment also tends to slow the speed at which the handle drive 20 can be rotated. The articulated handle arm 22 permits the user to choose the best compromise between rotation speed and leverage and comfort of operation.

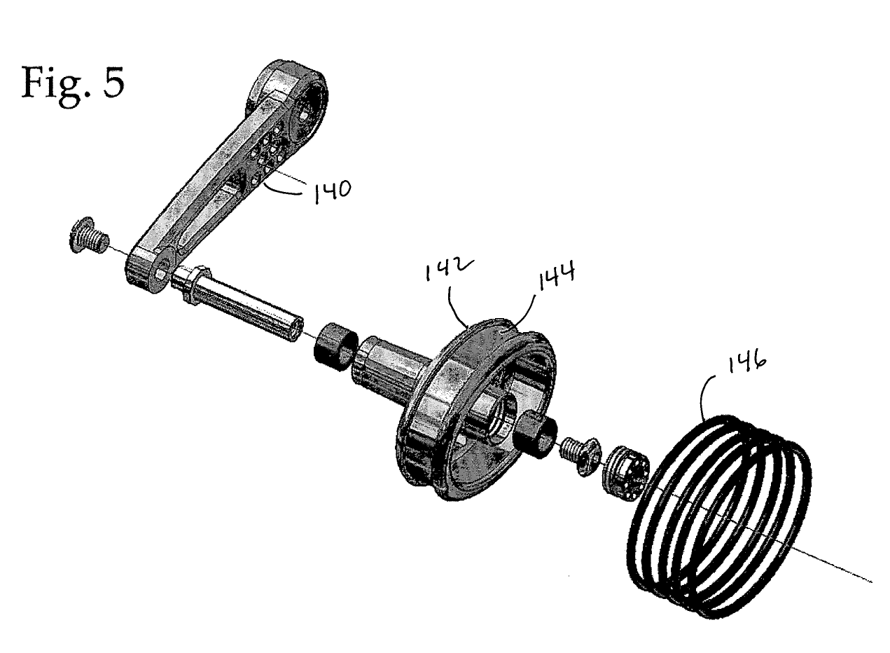

With reference to FIG. 5, an alternative handle arm 140 and handle knob 142 are shown. The handle arm 140 is not articulated, and thereby provides only a single radius of rotation and effective length, but is nevertheless satisfactory for use in the spinning reel 10. The handle knob 142 is oval, and thereby provides relatively flat opposed surfaces for gripping the handle knob 142. The handle knob 142 is provided with a channel 144 receiving a plurality of O-rings 146 in side-by-side relationship, and these O-rings provide the comfortable and grippy surface of the knob 142.

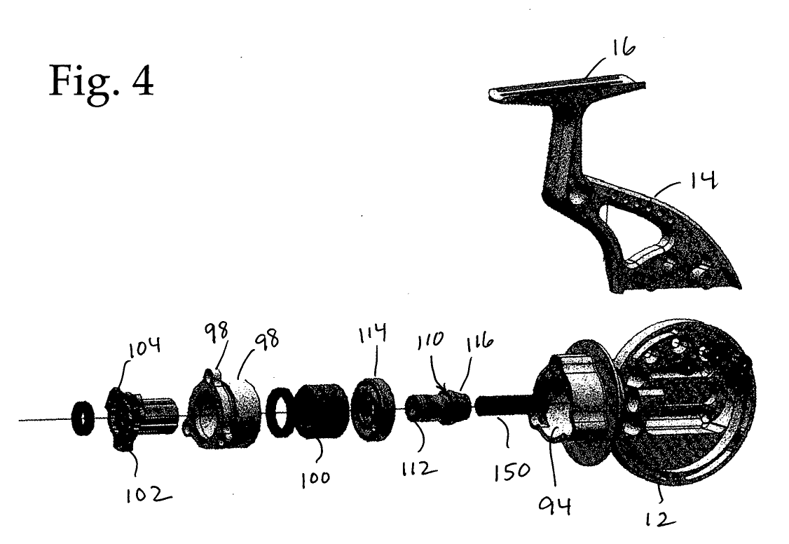

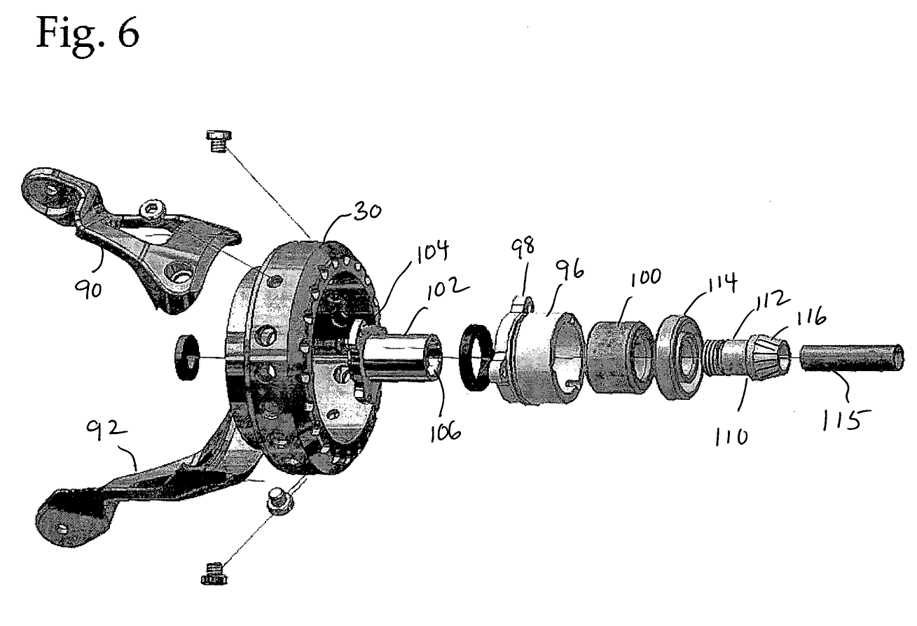

With reference to FIGS. 1-4 and 6, the handle drive 20 turns the drive gear 64 to rotate the rotor 30 and the line pickups 32 and 34 supported on the rotor 30 by line roller brackets 90 and 92. FIGS. 4 and 6 each include some of the same parts, to better illustrate how they fit and work together. The body 12 mounts the cover 60 and handle drive 20, presenting teeth 120 of drive gear 64 to pinion gear 110 supported in the body 12. The body 12 defines a clutch housing recess 94 which receives a generally tubular clutch housing 96. The ears 98 of the clutch housing prevent the clutch housing from rotating in the clutch housing recess 94, and also provide attachment points for securing the clutch housing in the clutch housing recess by machine screws, not shown. A one-way clutch 100 is received in the clutch housing 96, and the clutch 100 is of the type having roller bearings which permit one-way rotation of a rotor drive 102 inserted therein. The outer diameter of the clutch 100 is pinned to the clutch housing 96 so that the clutch 100 itself cannot rotate therein. The rotor drive 102 has radial flanges 104 at one end for mounting the rotor 30, and has a threaded opening 106 at the other end for securing pinion gear 110 therein. Shank 112 of the pinion gear 110 is supported on a pinion gear bearing 114, positioned adjacent the one way clutch 100 and as best seen in FIG. 2, teeth 116 of pinion gear 110 mesh with teeth 120 of drive gear 64. Thus, when the drive gear 64 is rotated by the handle drive 20, the pinion gear 110 and rotor drive 102 attached thereto cause corresponding rotation of the rotor 30.

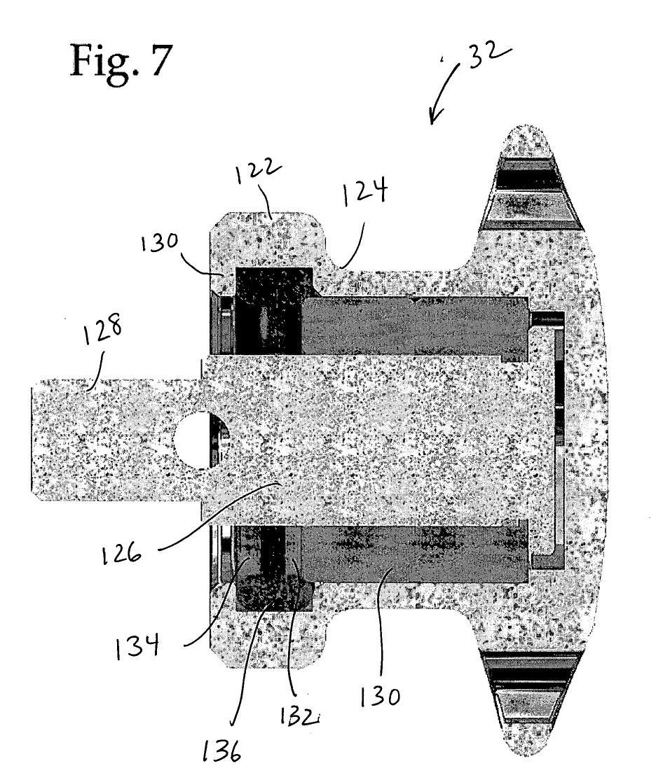

The line pickups 32 and 34 are supported on the rotor 30 by the line roller brackets 90 and 92. It is desirable that the line pickups 30, 32 do not impede or minimally act on line passing over them. With reference to FIG. 7, the line pickup 32 is provided as a line roller 122, including a channel 124 for receiving and guiding line. A mounting stud 126 is secured to bracket 90 by threaded end 128 and a nut 129 (FIG. 1). A roller bearing 130 is provided between the mounting stud and the line roller 122. O-ring 132, seal 134 and O-ring 136 are inserted between the end of roller bearing 130 and flange 138 of the line roller 122 for purposes of securing the line roller 122 on the bearing 130 and stud 126. This arrangement is surprisingly strong in its ability to retain the line roller 122 on the mounting stud 126, yet provides very minimal friction with respect to rotation of the line roller 122 and seals the bearing 130 against intrusion of water.

With reference to FIGS. 1, 2 and 8-11, the mounting of the spool 40 relative to the body 12 and rotor 30 are illustrated, together with the drag assembly 50. In general, the spool 40 is mounted on a shaft 150 in conjunction with drag assembly 50, more fully described below. The shaft 150 extends through the rotor drive 102 and an axial opening in the pinion gear 110. A shaft seal 152 is fitted in the rotor drive 102 to prevent water from infiltrating the clutch housing and the clutch 100 and bearing 114 therein. A cam 154 is mounted at the handle end of the shaft 150 and a stud 156 on the drive gear 64 engages with the cam 154 to reciprocate the shaft 150.

The distal end 160 of the shaft 150 is stepped to a smaller diameter at shoulder 162. The distal end 160 has opposed flat surfaces for purposes of keying parts thereto, as more fully discussed below.

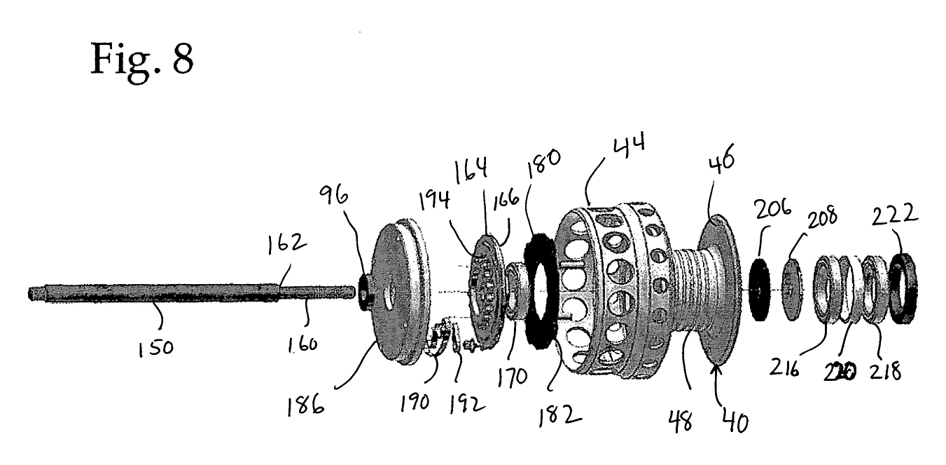

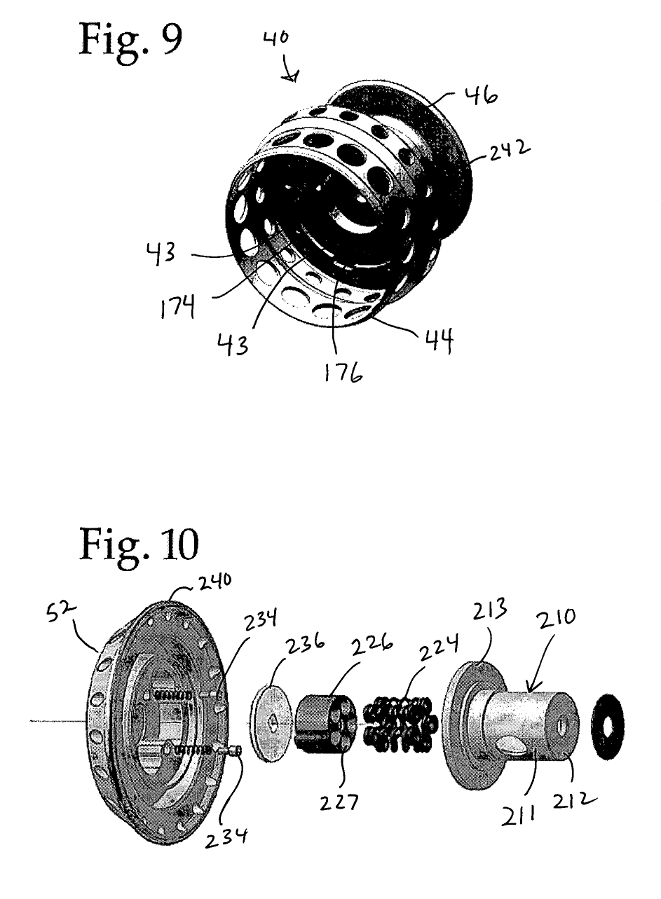

The spool 40 fits over the distal end of shaft 160, and is supported and flanked by the drag assembly 50. With reference to FIG. 8, a clutch plate 164 is keyed to the distal end 160 of the shaft, and is received butte against the shoulder 162. The clutch plate 164 has a smooth annular front surface 166, surrounding a bearing stud 168, seen in FIG. 2. A bearing 170 fits over the bearing stud 168 and is received in a bearing cup 172 formed in inner spool end wall 43 of the spool 40, as best seen in FIG. 9. The inner spool end wall 43 defines a flat drag washer surface 174 surrounding the bearing cup, and juxtaposed the clutch plate drag surface 166. The spool 40 further defines key openings 176 surrounding the drag washer surface 174, and a drag washer 180 with complementary keys 182 is received on the drag washer surface 174 for rotation with the spool 40. Thus, the drag washer 180 is positioned between the inner spool end wall 43 of spool 40 and the clutch plate 164, with the clutch plate 164 keyed to the shaft, such that the spool 40 is rotatable on the shaft 150 upon overcoming frictional forces between the clutch plate 164 and drag washer 180.

A clutch cover 186 mounts a drag clicker assembly 188, which includes a spring 190 and clicker arm 192. The clicker arm engages clicker detents 194 on the rear of the clutch plate 164. The clutch cover includes a low-friction shaft seal 196, and is mounted to the spool 40 to cover and protect the clutch plate 164 and drag washer 180. The spool 40 has a skirt 44 extending from inner end wall 43, that spans the space between the inner end wall 43 and the rotor so as the spool 40 and shaft 150 are reciprocated by the handle drive 20.

With continued reference to FIGS. 8-11, the drag assembly 50 is further illustrated. The spool 40 has a second drag washer surface 200, which is defined on the opposite side of the spool cross wall 42 defining the first drag washer surface 174. The spool has a cylindrical drum 48, with an interior cylindrical surface 204 surrounding and extending from the drag washer surface 200. A drag washer 206 is positioned adjacent the drag washer surface 200, and a clutch plate 208 is keyed and fitted on the distal end 160 of shaft 150, so that the clutch plate 208 does not rotate with a spool 40. A generally tubular spring housing 210 has a pressure plate surface 212 on the end thereof. The spring housing 210 is inserted in the interior of drum 48 and the pressure plate surface 212 is thereby positioned to apply pressure to the clutch plate 208, drag washer 206, spool cross wall 42 and drag washer 180, bearing against clutch plate 164 that rests against shoulder 162 of shaft 150.

The tubular spring housing 210 also further mounts the spool 40 for rotation about the distal end 160 of shaft 150. For this purpose, spool bearings 216 and 218, separated by spacer 220, are fitted over the tubular barrel 111 of spring housing 210 and inside the drum 48. A seal 222 is also preferably provided. A plurality of drag force springs 224, which is preferably five springs, are positioned in the barrel 211 of spring housing 210, to apply pressure to the pressure plate 212. The springs 224 are also received in an adjustment nut 226, which has openings 227 for receiving the ends of the drag force springs 224. The adjustment nut 226 has key flanges 228, which are received in mating grooves on the inside of barrel 211, so that the adjustment does not rotate with respect to the barrel. The adjustment nut has an axial threaded opening 230, which is threaded onto the distal end 160 of shaft 150. Thus, as the adjustment nut 226 is tightened on the shaft 150, the springs 224 are compressed to increase the drag force.

The drag assembly 50 further includes the drag adjustment knob 52, which is secured to the flange 213 of spring housing 210. The drag adjustment knob 52 thereby turns the spring housing 210 and the adjustment nut 226 therein, to tighten the adjustment nut 226 on the shaft 150 and thereby compress springs 224 to increase the drag force, or to loosen adjustment nut 226 and decrease the drag force. The adjustment nut 226 slides inwardly and outwardly with respect to the barrel 211 of spring housing 210 as the adjustment nut 226 is tightened or loosened, the sliding motion being accommodated by the key flanges 228.

Drag adjustment is audibly indicated by the action of two spring biased clicker pins 234 acting on clicker plate 236 keyed to the shaft, the clicker plate 236 defining detents 237 that produce noise as the clicker pins 234 are dragged across them. The clicker detents 337 are best seen in FIG. 12.

To summarize the operation of the drag assembly, drag washer 180 is positioned between clutch plate 164 and the drag washer surface 174 on cross wall 42 of spool 40. Drag washer 206 is positioned between clutch plate 208 and drag washer surface 200 on cross wall 42 of spool 40. The drag adjustment knob 52 is rotated to adjust the compression of springs 124, and thereby creating frictional drag force resisting the rotation of spool 40. The spool 40 is rotatably mounted with respect to the shaft 150 and the clutch plates 164 and 208, so that the spool may rotate and release line if the drag force is overcome. The spool 40 is mounted on a plurality of ball bearings, namely bearings 170, 216 and 218, so that the spool 40 rotates freely in the absence of drag force, whereby the drag force is the primary and adjustable impediment to spool rotation.

As seen in FIGS. 1, 2 and 13, the drag adjustment knob 52 substantially covers the outer end wall 46 of spool 40, and in the preferred embodiment shown, has a peripheral rim 240 that has a diameter that is incrementally larger than the diameter of the peripheral edge of outer spool end wall 46. This permits the drag adjustment knob to be rotated by engaging the peripheral rim 240 from the handle area of reel 10, such as by extending a finger or thumb forwardly while holding the handle knob 24. Adjustment may be accomplished while line is playing out from the spool 40 and one of line pickups 32, 34. Although it is preferable that the drag adjustment knob 52 have a diameter incrementally larger than the adjacent outer spool end wall 46, it will be appreciated that the diameter may be slightly smaller, if the drag adjustment knob is still engageable from the handle area of reel 10.

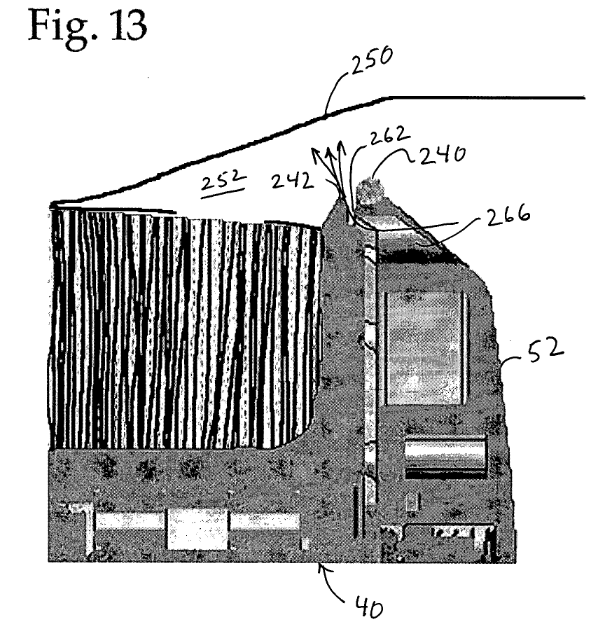

As seen in FIG. 13, when casting the line 250 pays out over the outer end wall 46 of spool and the peripheral rim 240 of the drag adjustment knob 52. The peripheral rim 240 is smooth and will not nick or break line 250 if the line should bear against it.

With continued reference to FIG. 13, the peripheral rim 240 of the drag adjustment knob 52 is positioned closely adjacent but spaced from the periphery 242 of spool end wall 46. As line 250 is rapidly deployed from the spool 40 during casting, it is believed that a partial vacuum and/or turbulence is created under the deploying line 250, as indicated at 252, and that this partial vacuum and/or turbulence may impede the deployment of line and cause a reduction of cast distance.

To overcome this difficulty, the drag adjustment knob 52 is provided with a plurality of openings 260 adjacent the drag knob rim 240 such that an airflow may be established into the openings 260 and out of the gap 262 between the drag knob rim 240 and the peripheral rim 242 of the spool end wall 46. This airflow is believed to reduce any partial vacuum and turbulence in this area and create an air cushion lifting the line 250 above the spool periphery 242 and drag adjustment knob rim 240, thereby reducing the deployment of force necessary to play out line and increasing casting distance.

When fishing is done, a fish hook or lure with fish hook can be stored by inserting it in a hook holder 270 extending from the mounting leg 14. The hook holder 270 defines an opening 272 for receiving a hook, and applying tension to the line 250 will retain the hook.

Accordingly, a spinning reel has been described that admirably achieves the objects of the invention herein. It will be appreciated that the spinning reel described is illustrative of the invention, but that modifications may be made without departing from the spirit and scope of the invention, which is set forth in the following claims.

I claim:

1. An improved spinning reel of the type having a body, a rotor and line pick-up rotatably mounted on the body, a shaft mounted for reciprocating movement with respect to the body and rotor, a spool rotatably mounted on the shaft, a drag assembly permitting adjustably controlled rotation of the spool with respect to the shaft to release line at an adjusted drag force, and a handle drive mounted on the body for rotating the rotor and reciprocating the shaft, the improvement comprising a handle arm and handle knob of the handle drive, the handle arm having a base arm and a distal arm adjustably secured together for selecting an effective handle length and radius of rotation of the handle knob.

2. An improved spinning reel of the type having a body, a rotor and line pick-up rotatably mounted on the body, a shaft mounted for reciprocating movement with respect to the body and rotor, a spool rotatably mounted on the shaft, a drag assembly permitting adjustably controlled rotation of the spool with respect to the shaft to release line at an adjusted drag force, and a handle drive mounted on the body for rotating the rotor and reciprocating the shaft, the improvement comprising a handle of the handle drive having a handle knob, the handle knob defining a channel, and a plurality of ganged O-rings deployed in the channel to provide the grip surface of the knob.

3. An improved spinning reel as defined in claim 2 wherein the knob has an oval configuration.

4. An improved spinning reel of the type having a body, a rotor and line pick-up rotatably mounted on the body, a shaft mounted for reciprocating movement with respect to the body and rotor, a spool rotatably mounted on the shaft, a drag assembly permitting adjustably controlled rotation of the spool with respect to the shaft to release line at an adjusted drag force, and a handle drive mounted on the body for rotating the rotor and reciprocating the shaft, the improvement being in the drag assembly and comprising two drag washers deployed on drag washer surfaces defined on opposite sides of a spool wall, a first clutch plate keyed to the shaft and operating on one of the drag washers, a second clutch plate keyed to the shaft and acting on the other of the drag washers, and at least one spring adjustably compressed to apply spring force biasing on the second clutch plate, the drag washers and spool wall against the first clutch plate.

5. An improved spinning reel as defined in claim 4 wherein the spool is rotatably mounted on the shaft by ball bearings.

6. An improved spinning reel of the type having a body, a rotor and line pick-up rotatably mounted on the body, a shaft mounted for reciprocating movement with respect to the body and rotor, a spool rotatably mounted on the shaft, a drag assembly permitting adjustably controlled rotation of the spool with respect to the shaft to release line at an adjusted drag force, and a handle drive mounted on the body for rotating the rotor and reciprocating the shaft, the improvement comprising a drag adjustment knob mounted adjacent to a spool wall, the lip of the drag adjustment knob and the periphery of the spool wall defining a gap therebetween, and the drag adjustment knob defining a plurality of openings establishing air communication to the gap.

7. An improved spinning reel of the type having a body, a rotor and line pick-up rotatably mounted on the body, a shaft mounted for reciprocating movement with respect to the body and rotor, a spool rotatably mounted on the shaft, a drag assembly permitting adjustably controlled rotation of the spool with respect to the shaft to release line at an adjusted drag force, and a handle drive mounted on the body for rotating the rotor and reciprocating the shaft, the improvement comprising a drag adjustment knob mounted adjacent to an outer spool end wall. The drag adjustment knob having a peripheral rim having substantially the same or greater diameter than the diameter of the periphery of the adjacent outer spool end wall, wherein the drag adjustment knob is accessible for manipulation from the handle drive of the reel.

8. A line roller for a line pick-up of a spinning reel comprising a mounting stud, a line roller rotatably mounted on the mounting stud by a roller bearing, and the line roller secured on the mounting stud by at least one O-ring captured between the roller bearing and a flange of the line roller.
